(19) United States
(12) Patent Application Publication
(10) Pub. No.: US 2019/0318580 A1
(43) Pub. Date: Oct. 17, 2019

(54) Scalable Multi-Player Game with a Strategic Component

(71) Applicant: Burton SIMON, Silverthorne, CO (US)

(72) Inventor: Burton SIMON, Silverthorne, CO (US)

(21) Appl. No.: 16/382,044

(22) Filed: Apr. 11, 2019

Related U.S. Application Data
(60) Provisional application No. 62/657,329, filed on Apr. 13, 2018.

(51) Int. Cl. G07F 17/32

(52) U.S. Cl. CPC G07F 17/3288; G07F 17/3276; G07F 17/3244

(57) ABSTRACT

The present invention provides methods and an apparatus for administering a lottery-like game between a host computer and a plurality of peripheral user interface devices, where numbers (or other identifiers) are selected from a selection set by placing one of two types of electronic tokens on the desired selection (i.e., type 1 and type 2 tokens). Players hope to choose the winning number as with other lotteries, but the winning number is determined based on the collective placements of type 1 and type 2 tokens by the players, and not by a random number generator as with other lottery games. Players use type 1 tokens to choose numbers they hope will win. Additionally, players are able to designate numbers that are ineligible to win with type 2 tokens. The methods and apparatus of the present invention are able to transmit and collect necessary data to determine the winners.

### CROSS-REFERENCE TO RELATED APPLICATIONS

This application claims priority from U.S. Provisional Patent Application No. 62/657,329, filed Apr. 13, 2018, which is incorporated by reference herein to the extent that there is no inconsistency with the present disclosure.

### FIELD OF THE INVENTION

The present invention is directed towards systems and methods of administering a game, including transmitting and collecting necessary data between a large number of players using game interface devices and a host computer over a network. The present invention is able to administer a lottery-like game, where the system receives data reflecting choices by made by the players, and processes this data to determine the eventual winner or winners. Additionally, the system is also able to provide and administer an unlimited number of automated players (bots) able to play along with human players.

### BACKGROUND OF THE INVENTION

The present invention generally relates to methods and apparatuses able to administer multi-person games, and more particularly to lottery-like games that can be played by a large number of people and where prizes can be awarded. The game administered by the present invention can be played over the internet or in a physical location including sports bars or casinos. The game can also be administered by selling tickets at convenience stores, as lottery tickets are often sold. In an embodiment, the apparatus of the present invention consists of a central processor connected to a plurality of peripheral user interface devices through a network.

There are many examples of games that are designed to be played by a large number of people. Some of them are well established in American culture, like lotteries and bingo. Lotteries are games of chance where players choose or are assigned numbers, and the winning numbers are determined by a random process that is statistically independent of the particular numbers held by the players. Bingo is a game where players choose or are assigned a matrix of numbers, and a random sequence of numbers is announced. The winners are the players whose cards are first to have a row, column, or diagonal made up of announced numbers. More recently, fantasy sports, and various social games have proliferated on the internet. These games are also designed to be played simultaneously by large numbers of people connected by a computer network. As described herein, games that can be played by arbitrarily large numbers of players without altering the rules are referred to as “scalable”. The game generally described by the present invention is more closely related to lotteries than other examples of scalable games.

In common lottery games, lottery tickets are offered for sale to a potentially unlimited number of players. Each ticket sold has a collection of numbers associated with it, often (but not always) chosen by the purchaser of the ticket. After a set time period is over, tickets are no longer sold, and a collection of numbers is randomly selected for the lottery game to be the winning numbers, such as by a random number generator on a computer, or selecting numbered ping pong balls from a barrel (which is a mechanical random number generator, as opposed to an electronic random number generator), and tickets with numbers matching the selected winning numbers are winning tickets. Each ticket may be unique so that there can be only one winning ticket per game, or duplicate ticket numbers may be allowed so that there can be more than one winning ticket per game. If no ticket sold has the winning number, there will be no winner for that game and prizes can be carried over to a subsequent game.

However, a downside to current lottery systems is that they are passive games that do not allow skill or input from the players to affect the outcome of the game. Instead, the outcome of each round of the game is determined completely at random. Accordingly, it is desirable to be able to administer a “lottery-like” game, which is similar to lottery games, but which involves and rewards skillful play by the players instead of relying on random statistical chance to determine the outcome. It is also desirable to provide a lottery-like game which is administered without the use of a random number generator to determine the winning tickets. One such game is described in U.S. Pat. No. 8,727,870 (Burton Simon) where the smallest number not chosen by another player wins; however, it is desirable to provide and be able to administer other lottery-like games which have different rules and features and provide additional avenues for players to utilize strategy to affect the outcome of the game.

U.S. Pat. No. 8,930,242 (Sheffield, et.al.) describes an auction system where the lowest unique bid is the winning bid for an item being sold by auction. The method for determining the winning player/bidder is therefore similar in the lottery-like game of Simon. However, as Sheffield et.al. is a system for running an auction, the winning bidder pays the auction house (or seller) the winning bid amount in exchange for the item for sale, which is different from a lottery-like game, i.e., in a lottery-like game, tickets with larger numbers do not cost more than tickets with small numbers. More importantly, in Sheffield et.al. bidders are told immediately if their bid is not a potentially winning bid with respect to bids already made (so they can make another bid, which is how the auction house makes a profit). This feature would ruin a lottery-like game since lottery-like games must keep all information about winning numbers secret (or unknown) until tickets are no longer being sold. Furthermore, there can never be more than one winning bid in an auction, or a second place bid, etc., so the auction system logic described in Sheffield, et.al. is different in purpose and in design from any lottery-like game.

The game administered by the present invention is different from the prior art (lottery games, lottery-like games, auctions, or otherwise) in a number of ways, including but not limited to, the presence of automated players, strategic decisions by the players that will determine the winners, and how the host computer of the present invention must collect, process and transmit data necessary to administer the game. These features will be apparent from the following discussions.

### SUMMARY OF THE INVENTION

The present invention is directed to methods and an apparatus for administering a game and transmitting and collecting necessary data between a large number of players over a network. In an embodiment of the invention, the apparatus is able to collect specialized data packets from multiple sources, process the data packets, summarize the processed data in a special electronic histogram, and broadcast the histogram. Additionally, the apparatus is able to collect and process data from an unlimited number of human players. In an embodiment, the apparatus administers the game for a “house” and allows the house to provide an unlimited number of automated players (bots) to play along with the human players.

In one aspect, the present invention provides methods and an apparatus for administering a lottery-like game where data corresponding to the actions and strategies of the players are received and analyzed by the house and used to determine the eventual winner or winners. Accordingly, there is a strategic component to the game, which means the system and methods for administering the game must be different from those use for conventional lottery games. For example, the present invention does not use a random number generator (or any other source of randomness) to determine winning players, and is therefore different in kind from all lottery games administered in the prior art since they require random number generators of some kind. Furthermore, the present invention is infinitely scalable, so it can be played by any number of players (greater than 2) without altering the rules in any way. Embodiments of the present invention provide a lottery-like game that can be played by a small group of people, such as a party game among friends or family; a larger group of people, like a keno game at a casino; or a very large number of people playing the game, similar to state lotteries where tickets are purchased across various physical locations, or the internet. The game of the present invention optionally features automated players, i.e. “bots”, that use randomized strategies (such as the Nash equilibrium) allowing an unlimited number of players in the game even if the number of human players is limited. Optionally, entry fees can be collected similar to common lottery games, and prizes distributed to the winners.

In an embodiment, the players select numbers (or other items) from a selection set, similar to common lottery games, but the choice is selected by placing or linking one of two types of electronic tokens (type 1 and type 2 tokens) on or with the desired choice. Players hope to choose the winning number as with other lotteries, but the winning number is determined based on the collective placements of type 1 and type 2 tokens by the players, and not by a random number generator as with other lottery games. Players use type 1 tokens to choose numbers or items they hope will win. Additionally, players are able to designate numbers or items that are ineligible to win with type 2 tokens. The methods and apparatus of the present invention are able to transmit and collect necessary data to determine the winners. In other words, in addition to selecting numbers players believe may be winning numbers, players can place “bombs” on certain numbers, thereby preventing those numbers from winning and increasing the player's own chances at winning. The game features automated players, “bots”, that use randomized strategies based on the Nash equilibrium (preferably), allowing an unlimited number of players in the game. Entry fees can be collected similar to common lottery games, and prizes distributed to the winners. A summary histogram provides details of the round of the present invention, and is broadcast to the players and/or spectators after the round. A progressive jackpot game can be made from multiple rounds of the present invention, by gradually expanding the selection set and increasing the jackpot after each round that the jackpot is not won

In an embodiment, the present invention provides a method of administering an interactive game between a host computer and a plurality of peripheral user interface devices (herein also referred to as game interface devices and user interface stations) comprising the steps: a) transmitting from a host processor a discrete ordered selection set to the plurality of peripheral user interface devices, wherein the discrete ordered selection set comprises a plurality of selectable ranked items; b) providing on each user interface device a number of electronic type 1 tokens and electronic type 2 tokens; c) opening an entry period where players are able to join the game during the entry period through the user interface devices; d) opening a selection period, wherein during the selection period the type 1 and type 2 tokens associated with each user interface device, independently from one another, are able to be linked with one or more of the selectable ranked items; e) closing the entry period wherein after the entry period is closed, no further players are able to join the game; f) closing the selection period wherein after the selection period is closed, no further type 1 and type 2 tokens are able to be linked to one or more of the selectable ranked items through the user interface devices, and wherein the closing of the selection period occurs after the closing of the entry period; g) transmitting data from each user interface device to the host computer when the selection period is closed, wherein the transmitted data comprises which selectable ranked items are linked to the type 1 and type 2 tokens from each user interface device; h) identifying via the host computer the smallest or lowest ranked item of the selectable ranked items having the least nonzero number of linked type 1 tokens from the transmitted data from the user interface devices and no linked type 2 tokens from the transmitted data from the user interface devices, and designating the identified smallest or lowest ranked item as the winning item; and i) determining via the host computer one or more winning players for the game, wherein the one or more winning players are players who linked a type 1 token to the winning item through the user interface devices. Additionally, the results of the game are transmitted or broadcast to the plurality of peripheral user interface devices, where a summary of the results are displayed on the plurality of peripheral user interface devices. Optionally, the results of the game are broadcast to devices allowing players, spectators, or both to view the results.

In a further embodiment, the host computer provides one or more automated players (or “bots”) wherein each automated host player randomly links a number of electronic type 1 and type 2 tokens with one or more of the selectable ranked items during the selection period. In other words, the bots are also allotted type 1 and type 2 tokens, which are placed in a similar manner as human players. In an embodiment, the items selected by the automated players are selected from the selection set utilizing a probability distribution function. In a further embodiment, the probability distribution is the Nash equilibrium strategy, or one approximately equal to it.

Once the selection period has ended, the host computer identifies the smallest or lowest ranked item of the selectable ranked items having the least nonzero number of linked type 1 tokens and no linked type 2 tokens from the transmitted data from the user interface devices (the human players) and each automated host player.

Optionally, the automated players are programmed so they will not select the same type 1 item more than once, as this is an obvious strategic mistake. Additionally, the automated players are programmed to randomly select items for their allotted type 2 tokens. Optionally, the automated players are programmed so they will not select the same type 2 item more than once and/or will not place a type 2 token on an item that it already placed a type 1 token on, as these are also obvious strategic mistakes. In an embodiment, the type 2 tokens are placed on items utilizing a probability distribution function such as the Nash equilibrium strategy, or an approximation for it. The items selected by the automated players have the same status as those selected by human players with respect to determining the winning number and player(s), as described in above. It is therefore possible for some or all of the winning player(s) to be automated players.

In an embodiment, the user interface device (also referred to herein as a as game interface devices and user interface stations) refers to any device able to connect or communicate to the host computer through a network, including but not limited to, computers connected to the internet, a smart phone running an app designed for the present invention, or a stationary kiosk at a sports bar or casino or convenience store programmed for the present invention. The user interface device allows a player to link their type 1 and type 2 tokens on the desired items from the selection set. The data identifying which items have been linked to the type 1 and type 2 electronic tokens is transmitted to the host computer. In an embodiment, the user interface devices also allow players to change their minds on the placements of the type 1 and type 2 tokens, up until the time the selection period closes. Herein, a player's “final choices” or “final selections” are the selected numbers or items at the time when the selection period closes.

In preferred embodiments of the present invention, the items in the selection set are a range of whole numbers, so herein the terms “item” and “number” (from a choice set) will be used interchangeably.

The selection set contains all of the different possible items that can be selected by the players for their type 1 and type 2 tokens. Since the game is administered electronically, tokens are not physically placed on a number or item, but instead “placing” a token on a number or item refers to electronically linking a token with an item from the selection list. The items in the selection set can be letters, numbers or other kinds of identifying marks, images or symbols, together with a specified ordering (least element to greatest element). The selection set is announced in advance so the players know what items are available to be selected at the time the entry period opens, and how the items are ordered. In a preferred embodiment, the selection set is a set of whole numbers with the usual ordering. For example, in one embodiment the selection set is the range of whole numbers from 1 to 99, or from 1 to 1,000,000, and each player is able to select one or more numbers within this range to place their allotted type 1 and type 2 tokens. Alternatively, the selection set can be whole numbers with no limit. However, since the winning number will very rarely be larger than the total number of tokens played, it is a disadvantage to select extremely high numbers. In another embodiment the selection set consists of the letters of the alphabet in their usual order, and in another embodiment the selection set consists of the Roman numeral representations of the whole numbers. In yet another embodiment, the selection set consists of the whole numbers between 1 and 100, but the order is reversed, i.e., 100<99<98< . . . <1.

In a further embodiment, a plurality of simultaneous subgames having common entry periods and selection periods and having separate sets of selectable ranked items are provided by the host computer and transmitted to the user interface devices. The type 1 and type 2 tokens associated with each user interface device are able to be linked to one or more of the selectable ranked items in any of the sets of selectable ranked items associated with the different subgames. Players are able to place their tokens on items in any of the subgames so that the total number of type 1 and type 2 tokens they collectively place on the items in the selection sets is no more than the allotted numbers. In other words, the number of type 1 and type 2 tokens able to be collectively linked to the sets of selectable ranked items is finite, and when the common selection periods close, a winning item is determined for each subgame, and the winning players are players who linked type 1 tokens on the winning items in one or more of the subgames.

In an embodiment, a histogram is constructed by the host computer from the transmitted data and is electrically communicated to the user interface devices. Optionally, constructing the histogram comprises the steps of: a) determining the number of players that linked a type 1 token on each item in the selection set, and the number of players that placed a type 2 token on each item in the selection set, thereby generating a result set; b) displaying the result set as a histogram where a color-coded bar above each item in the selection set shows the number of type 1 and type 2 tokens linked to that item; and c) electrically communicating the histogram to the user interface devices along with a summary of winning items and prizes.

In one embodiment, the number of registered players (including the number of automated players, or “bots”) in each round is transmitted to the players and continuously updated during the entry period as players join the round, and the final player count is revealed when the entry period closes. This way players know how many total type 1 and type 2 tokens will be placed on the choice set (which is useful information for making strategic choices) before they finalize their own choices. Optionally, the time remaining until the entry and selection periods close are continuously displayed for the players as well.

In an embodiment, the present invention provides a method of administering an interactive game comprising of one or more rounds between a host computer and a plurality of peripheral user interface devices. Each round comprises the steps of: a) transmitting from a host processor a discrete ordered selection set to the plurality of peripheral user interface devices, wherein the discrete ordered selection set comprises a plurality of selectable ranked items; b) providing on each user interface device a number of electronic type 1 tokens and electronic type 2 tokens; c) opening an entry period where players are able to join the game during the entry period through the user interface devices; d) opening a selection period, wherein during the selection period the type 1 and type 2 tokens associated with each user interface device, independently from one another, are able to be linked with one or more of the selectable ranked items; e) closing the entry period wherein after the entry period is closed, no further players are able to join the game; f) closing the selection period wherein after the selection period is closed, no further type 1 and type 2 tokens are able to be linked to one or more of the selectable ranked items through the user interface devices, and wherein the closing of the selection period occurs after the closing of the entry period; g) transmitting data from each user interface device to the host computer when the selection period is closed, wherein the transmitted data comprises which selectable ranked items are linked to the type 1 and type 2 tokens from each user interface device; h) identifying via the host computer the smallest or lowest ranked item of the selectable ranked items having the least nonzero number of linked type 1 tokens from the transmitted data from the user interface devices and no linked type 2 tokens from the transmitted data from the user interface devices, and designating the identified smallest or lowest ranked item the winning item; i) determining via the host computer one or more winning players for the round, wherein the one or more winning players are players who linked a type 1 token to the winning item through the user interface devices; and j) determining if there is a single unique winning player in the round, in which case said unique winner is awarded a prize; wherein if there is no single unique winner in the round, the prize is not awarded, and another round is scheduled.

In a further embodiment, the provided selection set is larger in successive rounds. Preferably, each subsequent round has a larger prize. In an embodiment, the prize for a round is increased by a fraction of fees collected in a previous round. Optionally, a consolation prize is awarded to multiple winning players in rounds when there is no single unique winning player.

In an embodiment, the present invention provides a method of administering a game between a plurality of players comprising the steps of: a) providing one or more kinds of user interface devices for players to play the game; b) providing a discrete ordered selection set to the players wherein the selection set comprises a plurality of ranked items that can be selected by the players, and also providing a number of type 1 tokens each player will be allotted to place on items from said selection set, and also providing a number of type 2 tokens each player will be allotted to place on items from the selection set; c) opening an entry period wherein players are able to register to join the game during the entry period, after paying a fee; d) opening a selection period, wherein during the selection period registered players are able to use their user interface devices to place their allotted type 1 tokens on items from the selection set, and also to place their allotted type 2 tokens on items from the selection set, independently of other players' choices, so that multiple players are able to select and designate the same items during the selection period; e) closing the entry period wherein after the entry period is closed, no further players may register to join the game; f) closing the selection period wherein after the selection period is closed no further placement or re-placement of tokens is allowed, and wherein the placement of the players' tokens when the selection period ends are their final selections, and wherein the closing of the selection period does not occur before the closing of the entry period; g) collecting all the players' placements for type 1 and type 2 tokens, and identifying which items from the selection set had the least nonzero number of type 1 tokens placed on them, among those items that had no type 2 tokens placed on them; h) selecting the lowest ranked item among said identified items, and designating it as the winning number; and i) determining the one or more winning players for the game, wherein the one or more winning players are those players who placed type 1 tokens on the winning number.

Optionally, each player is able to place multiple type 1 tokens on desired items from the selection set, i.e., each player can select multiple numbers as potential winning numbers. Similarly, each player is optionally able to designate multiple numbers as being ineligible to win by placing type 2 tokens on them. In an embodiment, each player is allotted five type 1 tokens which are placed on items the player hopes will be winning numbers, and one type 2 token which is placed on an item the player wants to be ineligible to win (thus blocking other players from using that number to win).

By placing a type 1 or type 2 token on a given item from the selection set, a player does not prevent other players from doing the same. Instead, selecting an item causes that item to be designated as being selected by that particular player. In an embodiment, players can change their minds about their choices if they want, right up to the end of the selection period. In another embodiment, they cannot change their minds once they have selected their items. The selected items can be printed on a ticket for the player, or the selection recorded on a computer processor or computer readable medium. In an embodiment of the present invention, players buy tickets at a convenience store; wherein the tickets contain unique “passwords” allowing the ticket owners to access the game online at a specified web site later in the day (e.g., after the entry period closes, so they know the total number of players, but before the selection period closes) and enter their choices for placing their type 1 and type 2 tokens. In this embodiment, if a player wins, his/her ticket is the receipt for redeeming the prize at the convenience store it came from.

At the end of the selection period, all the players' selections are communicated to the host processor and recorded, in order to calculate the total number of type 1 and type 2 tokens placed on each item in the selection set. After the selection period ends, it is determined how many times each item has been selected with type 1 tokens, and which items have been designated as ineligible to win because they contain type 2 tokens. The winning player(s) are those who placed a type 1 token on the smallest item from the selection set which has been selected the least nonzero number of times during the selection period, among those items that were not designated as ineligible to win. Items which were not selected with a type 1 token are ignored, so the winning item is always among those that have been selected at least once.

As used herein, a “unique winning player” or “unique winner” is defined to be a player that wins a round of the game of the present invention, and is the only winner in that round. In other words, when the section period closes, if the winning number has only one type 1 token on it then the player that placed that token is a unique winning player. Thus, there is a unique winning player whenever there are one or more items from the selection set with exactly one type 1 token, and zero type 2 tokens on them. When there is no unique winning player there is a tie.

In case of ties (i.e., where multiple players select the winning number), multiple winners can be declared; or optionally, no winners can be declared. It is a mathematical fact that (unless every number with a type 1 token also has a type 2 token) there is always a winning number, which is the least item from the selection set, among those that had no type 2 tokens (eligible items), that had exactly k type 1 tokens, where k is the minimum nonzero number of times any of the eligible items were chosen. When k>1 there is no unique winner. In an embodiment, if there is not a unique winner the prize is carried over to one or more subsequent rounds until there is a unique winner. In another embodiment, when there is a tie, the plurality of winning players split the prize.

In a preferred embodiment of the present invention, when two or more different items have been selected with exactly one type 1 token, and have not been designated as ineligible to win with a type 2 token, the winning item (or 1st place item) is the lowest ranked item among them. Optionally, the other items with one type 1 token and zero type 2 tokens, in increasing order, can be designated as the 2^{nd} place item, the 3^{rd} place item, and so on. In another embodiment, the lowest ranked item with two type 1 tokens and zero type 2 tokens is the 2^{nd} place number, the lowest ranked item with three type 1 tokens and zero type 2 tokens is the 3^{rd} place number, and so on.

The entry and selection periods can be for any length of time, including several days, similar to many lotteries; to just a few seconds, if played in a social setting or sports bar setting. Preferably, there is enough time between when the entry period is closed and the selection period is closed so players have time to make their choices with knowledge of the total number of type 1 and type 2 tokens that will be placed on the selection set. In an embodiment, the number of total players, the total number of type 1 tokens and the total number of type 2 tokens is revealed to the players right after the entry period is closed so that players can adjust their strategies accordingly. In another embodiment, this information is not provided, leaving players to guess. Optionally, the entry and selection periods are closed after a pre-determined period of time elapses where the length of each period is known to the players at the outset of the game. Alternatively, the entry period is closed after a randomly chosen period of time within a specified range, such as any time between 1 to 2 hours. Ending the entry period of a game at a random time may incentivize players to join a current game earlier in order to ensure they join the game before it is too late. In another embodiment, the entry period is closed after a pre-determined number of players have joined. Particularly where the game of the present invention is provided via a computer network, a new round of the game can be provided immediately after the previous round ends.

In a further embodiment, the method comprises awarding a prize to the one or more players that placed type 1 tokens on the winning number (first place winners). Optionally, prizes are awarded to 2^{nd} place winners, 3rd place winners, and so on, where the n-th place number is determined by removing the first through (n−1)st place numbers and rerunning the algorithm for determining first place as described above. Optionally, a bet or fee is collected from each player each time the player joins a round of the game. In a further embodiment, the prize awarded to the winning players is a percentage of the bets or fees collected from the players. Preferably, the amount of the winnings paid to each n-th place player is the same. In an embodiment, the bets or fees are electronic units maintained on a computer processor and are collected from the players using a mobile device or computer processor connected to a network. Alternatively, the bets and fees are collected via a network of specially designed kiosks or slot machines, or at a convenience store.

In a further embodiment, the present invention provides one or more additional new rounds of the game after the initial round ends. The players can be the same from round to round or can change each round, and the selection set can be the same or different from round to round. In an embodiment, if there is not a unique winning player in any given round, the plurality of winning players split some fraction of the prize for that round, and the rest is carried over to the next round (a progressive jackpot game), until there is a round with a unique winner.

Accordingly, an embodiment of the present invention comprises repeating the following steps until there is a grand prize winner: a) providing one or more kinds of user interface stations for the players to play the game; b) providing a discrete ordered selection set to the players wherein the selection set comprises a plurality of ranked items that can be selected by the players, and also providing a number of type 1 tokens each player will be allowed to place on items from said selection set, and also providing a number of type 2 tokens each player will be allowed to place on items from the selection set; c) opening an entry period wherein the players are able to join the current round during the entry period; d) opening a selection period, wherein during the selection period the players are able to use their user interface device to place their allotted type 1 and type 2 tokens on items from the selection set, independently from the other players, so that multiple players are able to select and designate the same items during the selection period; e) closing the entry period wherein after the entry period is closed, no further players may join the current round; f) closing the selection period wherein no further placement or re-placement of tokens can be made, and wherein the placement of the players' tokens when the selection period ends are their final selections, and wherein the closing of the selection period does not occur before the closing of the entry period; g) identifying which items from the selection set had the least nonzero number of type 1 tokens placed on them, among items that had no type 2 tokens placed on them; h) selecting the lowest ranked item among said selected items, and designating it the winning number; and i) determining if there is a unique winning player for the round, wherein if there is a unique winning player in a round then the grand prize is awarded to said unique winning player and the game ends, otherwise if there is no unique winner in the round, the grand prize is not awarded, and at least a portion of the collected bets, or fees for that round are added to the unclaimed grand prize and used to determine the subsequent grand prize. Optionally, when there is no unique winning player in a round, the plurality of winning players can share a consolation prize from the collected bets or fees from that round.

In an embodiment, the players select their desired items for their type 1 and type 2 tokens from the selection set from user interface stations. Preferably, any bets, or fees are also collected from the players at the user interface stations. In one embodiment, the user interface stations are physical locations, such as kiosks at convenience stores or retail stores, able to record and print player selections. In another embodiment, user interface stations comprise one or more computer terminals connected to a network where the players make their selections electronically. Optionally, the user interface stations are handheld electronic devices (such as personal digital assistants and smartphones) connected to a network. In one embodiment, the game is provided to the players using a computer network where the selection set and items are electronic units maintained on a computer processor. In one embodiment the game is provided to players by selling tickets at a convenience store, wherein said ticket is valid for a designated round of the game, and the ticket contains information (e.g., a password, or a bar code) allowing the ticket owner to play the designated round of the game over the Internet, and claim prizes if they win.

In a further embodiment, the user interface is a smartphone app that allows players to join a round during the entry period, pay fees, and enter their type 1 and type 2 choices by dragging icons representing type 1 and type 2 tokens (e.g., coins for type 1 tokens and bombs for type 2 tokens) to the corresponding items in the selection set. The app allows players to move their icons around right up until the end of the selection period. In this embodiment, a) the players' apps send the players' choices to the host processor as soon as the selection period ends; b) the host processor assembles all the choices by all the players and determines the number of type 1 and type 2 tokens on each item in the choice set; c) the host processor determines the winning number, 2^{nd} place number, and so on; d) the host processor creates a color coded summary/result histogram for each player; and e) the host processor sends the personalized histograms to the players which are displayed on their smartphones by their apps.

In another embodiment, the present invention provides an apparatus for providing an interactive game between a plurality of players, where the apparatus comprises: a) a host processor programmed for collecting and processing input data, and outputting data and information relevant to the game; and b) one or more user interface stations connected to the host processor, where the one or more user interface stations are able to send player selection input to the host processor.

The host processor is programmed to: i) transmit to each user interface station a discrete ordered selection set, wherein the selection set comprises a plurality of selectable ranked items, and also provide to each user interface station a number of electronic type 1 and electronic type 2 tokens; ii) open an entry period where the players are able to join the game during the entry period through the user interface stations; iii) open a selection period, wherein during the selection period the type 1 and type 2 tokens associated with each user interface station, independently from one another, are able to be linked with one or more of the selectable ranked items; iv) close the entry period wherein after the entry period is closed, no further players may join the game; v) close the selection period, wherein after the selection period is closed, no further type 1 and type 2 tokens are able to be linked to one or more of the selectable ranked items through the user interface stations, and wherein the closing of the selection period occurs after the closing of the entry period; vi) transmit data from each user interface station to the host computer when the selection period is closed, wherein the transmitted data comprises which selectable ranked items are linked to the type 1 and type 2 tokens from each user interface station; vii) identify which selectable ranked items in the selection set, among those that did not contain type 2 tokens, contained the least number of type 1 tokens with at least r type 1 tokens, where r>0; viii) identify the smallest or lowest ranked item of the selectable ranked items that have at least r type 1 tokens and no type 2 tokens, and designate the identified smallest or lowest ranked item as the winning item; and ix) determine the one or more winning players for the game, wherein the one or more winning players are the players who linked a type 1 token to the winning item.

In a further embodiment, the one or more user interface stations comprise one or more computer processors connected to a network able to transmit player selection input to the host processor. In another embodiment, the user interface stations comprise one or more computer processors, one or more kiosks, one or more handheld electronic devices, or combinations thereof where each user interface station is able to send player selection input to the host processor. In a further embodiment, the host processor is able to notify a user interface station for a specific player whether that player has won.

In view of the above, it is an object of the present invention to provide and administer a lottery-like game where the winner is determined by the strategies and actions of the players, and not a random number generator, where the game can be adopted by a state, or other large institution, and offered as a game of chance and strategy for people to play, for a price, similar to current lotteries and scratch games. Such a game could be played over the internet, and/or by selling physical tickets at convenience stores. Such a game could be run for profit by the institution where winners are chosen according to the rules of the game and which may include progressive jackpots and other embellishments.

It is another object of the present invention to provide a social game that can be played, possibly for no cost, as an application for cell phones and other personal communication devices. It is another object of the present invention to provide a game that can be played for fun and/or prizes by a relatively small number of people in close proximity, such as at a casino, a party or at a bar or restaurant.

These and other objects and advantages of the invention shall become apparent from the following general and preferred descriptions of the invention.

### BRIEF DESCRIPTION OF THE DRAWINGS

FIG. 1 illustrates the high-level functionality of a preferred embodiment of the present invention. Players, using a specially designed app on their smartphones (or other electronic device connected to the internet), pay a fee and register to play in a round of the lottery-like game of the present invention. During the selection period of the round, the app allows players to independently choose which numbers from the selection set they want to place their type 1 and type 2 tokens, and then uploads their choices to the host processor when the selection period ends. The host processor takes all the player choices together, determines the winners, constructs a color-coded histogram that summarizes the results of the round (how many type 1 and type 2 tokens on each number, which number was the winning number, 2^{nd} place, etc.), and sends the histogram back to the players, which are displayed on their apps, along with notifications of prizes for winning players.

FIG. 2 shows an embodiment of a player interface screen that players use to place their Type 1 and Type 2 tokens. In this example the selection set is {1, 2, . . . , 100}, and the players are allotted three Type 1 tokens (displayed as coins) and two Type 2 tokens (displayed as bombs). In this example the players click and drag the icons for Type 1 and Type 2 tokens to the numbers they choose. Players can change their minds about their choices by moving the icons, until the selection period ends. The positions of the coins and bombs when the selection period ends determines the players' final choices.

FIG. 3 shows an embodiment of (hypothetical) results of a round of the game of the present invention in histogram form. The number of players is small in this example to keep things simple. The horizontal axis lists the elements of the choice set {1, 2, . . . , 9} and the vertical axis shows how many tokens of each kind were placed on the choices, by the players collectively. The blue squares making up the vertical bars correspond to type 1 tokens, and the “bombs” correspond to type 2 tokens; so for example there are four type 1 and two type 2 tokens on choice “2”. In this example the winning number is “6” since it is the smallest number with one type 1 token on it that does not have any type 2 tokens on it. The player that chose number “6” in this example is a unique winner.

FIG. 4 shows the results of another hypothetical round of the game of the present invention in histogram form with the same embodiment as FIG. 3. This time there is no unique winner since there are no numbers with exactly one type 1 token and no type 2 tokens. The winning number is “5” since there are no bomb-free choices with one type 1 token, and “5” is the smallest bomb-free choice with two type 1 tokens on it. The two players that chose “5” are both winners and split the prize. In this example, if another player had placed a type 1 token on “7” then he/she would have been a unique winner.

FIG. 5 shows the timeline for a round of the game in an embodiment of the present invention. At time e₀ the entry period opens, allowing players to register to play in the round. New players can register up to time e₁. After that they must wait until the next round to play. Between times s₀ and s₁ registered players choose where to place their type 1 and type 2 tokens. (FIG. 2 illustrates an embodiment of a player interface screen for placing type 1 and type 2 tokens.) Preferably, registered players can change their minds about their choices right up until time s₁. If players wait until time e₁ to make their choices then they will know exactly how many players are in the round (and therefore the number of type 1 and type 2 tokens played) since no new players can register after that time. In one embodiment e₀=s₀, meaning that players can begin to make their choices as soon as they register. Preferably e₁<s₁ so players have time to make (or re-think) their choices after the final player count is set. The showdown time t* must be after the selection period ends, but the gap between them can be small. At time t* the winning number and winning players are determined, and a message summarizing the round (e.g., FIGS. 3 and 4) is sent to all the players.

FIG. 6 shows the timeline for a progressive jackpot version of the game in an embodiment of the present invention. Each round follows the timeline described in FIG. 5, but there will typically be multiple rounds. The game continues until there is a round with a unique winning player, at which time the progressive jackpot (accumulated over the previous rounds) is awarded. Preferably the choice set for the i-th round {1, 2, . . . , Mᵢ} increases each time so there will eventually be a unique winning player, no matter how many total players there are.

FIG. 7 is a flow diagram showing the tasks of the host processor in a preferred embodiment of the present invention, e.g., FIG. 1. The embodiment illustrated in FIG. 7 also includes automated host players (or “bots”).

FIG. 8 is a flow diagram showing the determination of the winning number and winning player(s) in a preferred embodiment of the present invention.

FIG. 9 is a flow diagram showing an embodiment of the placing algorithm for the present invention (first place, 2^{nd} place, etc.). The algorithm for first place is the same in preferred embodiments of the present invention, however alternate algorithms are available for how the other places are determined.

FIG. 10 is a flow diagram showing how the payoffs to the winning players of a round are determined in an embodiment of the present invention.

FIG. 11 is a flow diagram showing how automated host players (bots) select numbers for their Type 1 and Type 2 choices in an embodiment of the present invention.

### DETAILED DESCRIPTION OF THE INVENTION

As used to describe the present invention, the following terms are defined as follows.

A “lottery” is a means of raising money by selling numbered tickets and giving prizes to the holders of numbers drawn at random (Google dictionary). In other words, the winning numbers in a lottery are chosen at random (i.e., by chance). A distinctive feature of many popular modern lotteries (like Power Ball) is the potentially unlimited number of players that can play, and the option for players to choose their own numbers. Herein, a “lottery-like game” is a game where players choose numbers (or other items from a “selection set”) as they would in a lottery, but the players that win prizes are determined by a fixed function of the players' collective choices, and not by chance. The game of the present invention is therefore a lottery-like game.

A “house” is the generic name for person or entity administering the game of the present invention. The house may be a bricks and mortar casino or business, or a web site on the internet, or the Multi-State Lottery Association, which runs large scale lottery games in the United States like Powerball. “House rules” are rules that have no effect on the logical operation of the game of the present invention, such as the size of the selection set, or the amount of time players have to make their choices, or the fees charged for playing.

A “Nash equilibrium strategy” for a multi-player game such as the game of the present invention, is a strategy where a player makes a choice randomly from a certain probability distribution. Said probability distribution has the property that if every player is using the strategy to make their choices, then no player would do better by changing to a different strategy (thus, an equilibrium). Very often Nash equilibrium strategies are good strategies, but there is no guarantee that it is the best response to every other strategy. Knowing the Nash equilibrium strategy does not guarantee winning, or even having an advantage over the other players. For the games of the present invention it is difficult, but not impossible, to compute or approximate the Nash equilibrium strategies. If the Nash equilibrium strategy cannot be calculated (e.g., if the allocated numbers of type 1 and type 2 tokens, n and m, are large), or if for any reason the house does not want to use the Nash equilibrium strategy for its bots, the bots can be programmed to make their choices in some other way, e.g., choose uniformly between a lower and upper bound set by the house.

A “unique winning player” or “unique winner” is a player that chose the winning number with a type 1 token, and was the only player that chose the winning number.

“Places” refer to 1st place, 2^{nd} place, 3rd place, and higher place numbers or winners.

“Bots” are automated (virtual) players provided by the house to compete along with the (human) players. Bots preferably play by the same rules as the human players, i.e., they are allotted the same number of type 1 and type 2 tokens. Bots can use the Nash equilibrium strategy to make their choices, but do not have to.

The “entry period” of a round of the present invention is an interval of time when potential players can register and pay any fees to play in the round.

The “selection period” of a round of the present invention is an interval of time when registered players can choose where to place their type 1 and type 2 tokens. In preferred embodiments of the present invention, the entry period ends before the selection period ends so that in the time between the end of the entry period and the end of the selection period, players can make their choices with knowledge of exactly how many players registered for the round. When the selection period ends, all the players' choices are communicated to the host processor.

The “showdown” occurs after the selection period ends in an embodiment of the invention. The showdown is when the host processor processes the players' choice data, determines the winner(s), constructs the summary histogram, and broadcasts the summary histogram to the players and/or spectators.

A “summary histogram” is the way the results of a round of the present invention are communicated to the players in a preferred embodiment. The horizontal axis of the histogram lists the items from the selection set. The histogram bars above each item show the number of type 1 and type 2 tokens that were (collectively) placed on that item by the players. By using various coloring schemes for the histogram bars, it is possible to show the winning number and other places, in addition to the numbers of type 1 and type 2 tokens on each item.

Overview

The present invention provides a method and system for administering a lottery-like game where the players select numbers (or other identifiers) similar to typical lottery games, but where the winning number is the smallest number chosen by at least one player with the property that no other number chosen by at least one player was chosen by fewer players, and the number is eligible to win. Players each choose n numbers to potentially win (using type 1 tokens), and m numbers to be ineligible to win (using type 2 tokens), where n is a fixed number greater than or equal to one, and m is a fixed number greater than or equal to zero. (The values of n and m can be considered “house rules”.) In other words, in addition to selecting numbers players believe may be winning numbers with type 1 tokens, players can also place “bombs” or “mines”, with type 2 tokens, on numbers they believe may otherwise be winning numbers, thereby preventing those numbers from winning, and thereby increasing their own chances at winning. The present invention therefore does not need or utilize random number generators or any other source of randomness to determine winners, and this fact alone makes the present invention different in kind from lottery games in the prior art. The present invention can be played by any number of players (greater than 2), and the players can optionally include virtual players (bots) controlled by the house.

The present invention provides an apparatus that allows players to play the game of the present invention. The apparatus a) allows players to register, pay fees, and choose where to play their allotted type 1 and type 2 tokens; b) communicates the players' choices to the host processor in specially formatted data packets; c) processes the data packets received from the players; d) summarizes the processed data in a specially formatted electronic histogram; and e) broadcasts the electronic histograms.

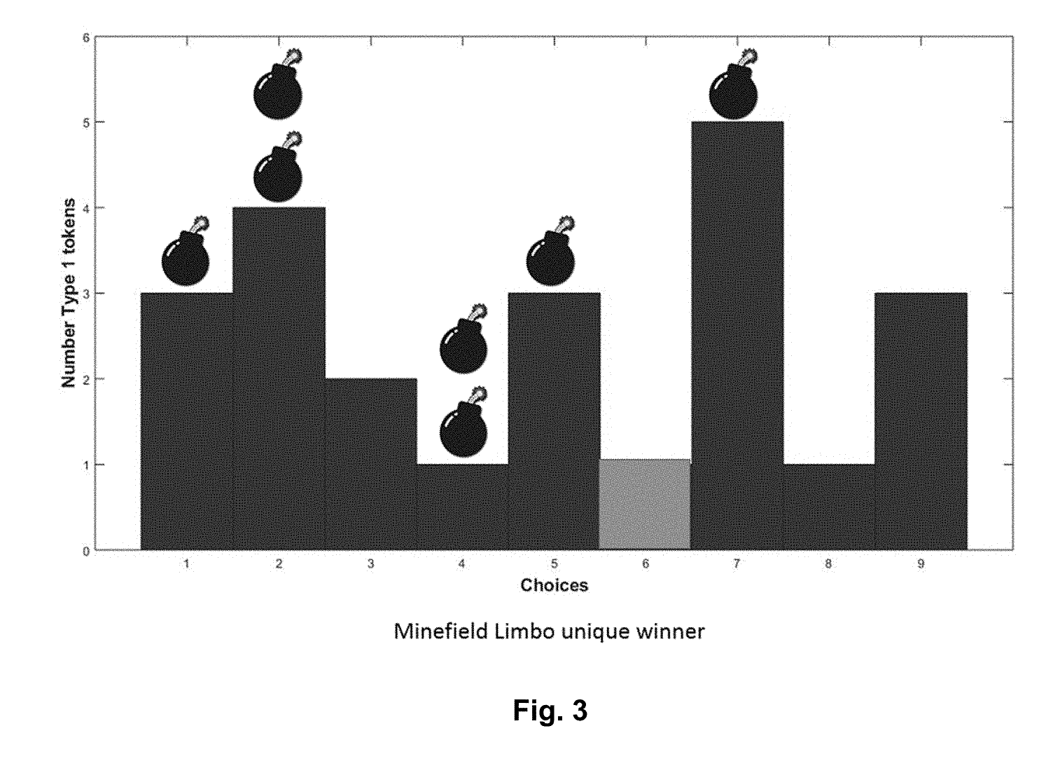

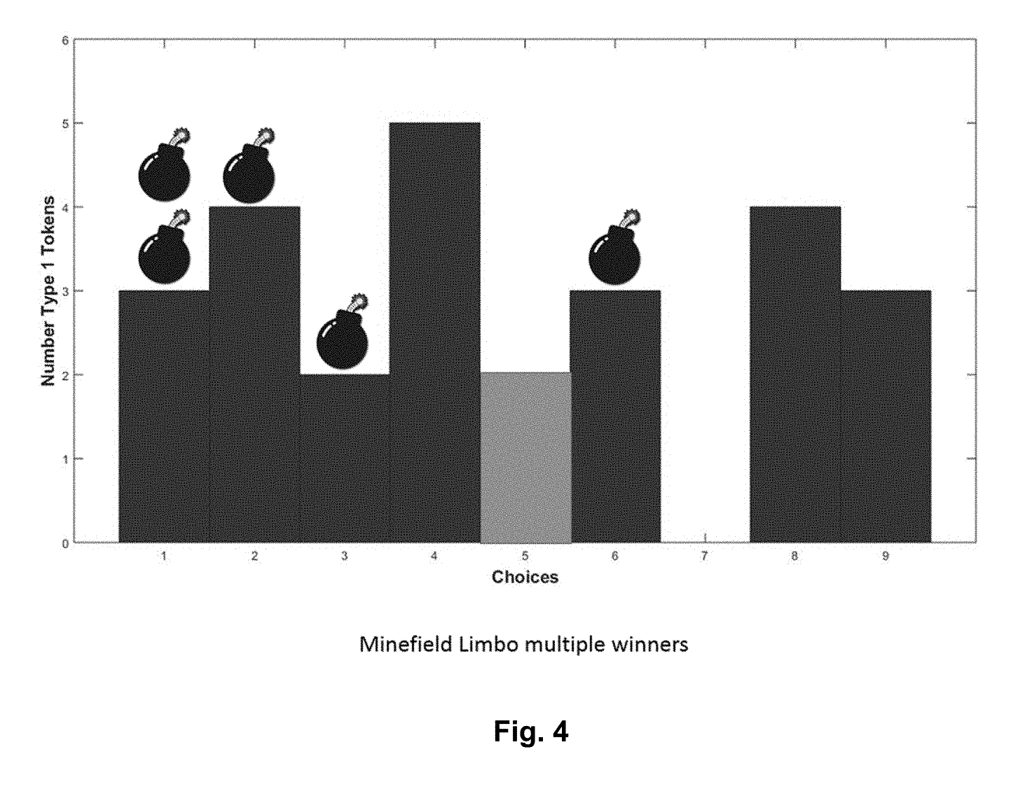

FIGS. 3 and 4 illustrate the outcome of a round of the game of the present invention (with a small number of players) using histograms. A histogram is a very good way to summarize the results of a round of the present invention. In the embodiment of FIGS. 3 and 4, above each number is a bar representing the total number of type 1 tokens that players collectively placed on that number, along with bombs representing the total number of type 2 tokens the players collectively placed on that number. From the histogram it is easy to determine the winning number by sight, and this is why preferred embodiments of the present invention produce them from the raw player-choice data and broadcast them to the players and potential spectators.

Entry fees can be collected for a round of the game of the present invention, similar to common lottery games, and prizes distributed to the winners. The prize amounts can depend on the number of players, e.g., a fraction of the total fees collected from the players for that round; or a fixed amount; or a progressive jackpot based on what happened in previous rounds, or any of a number of other possibilities.

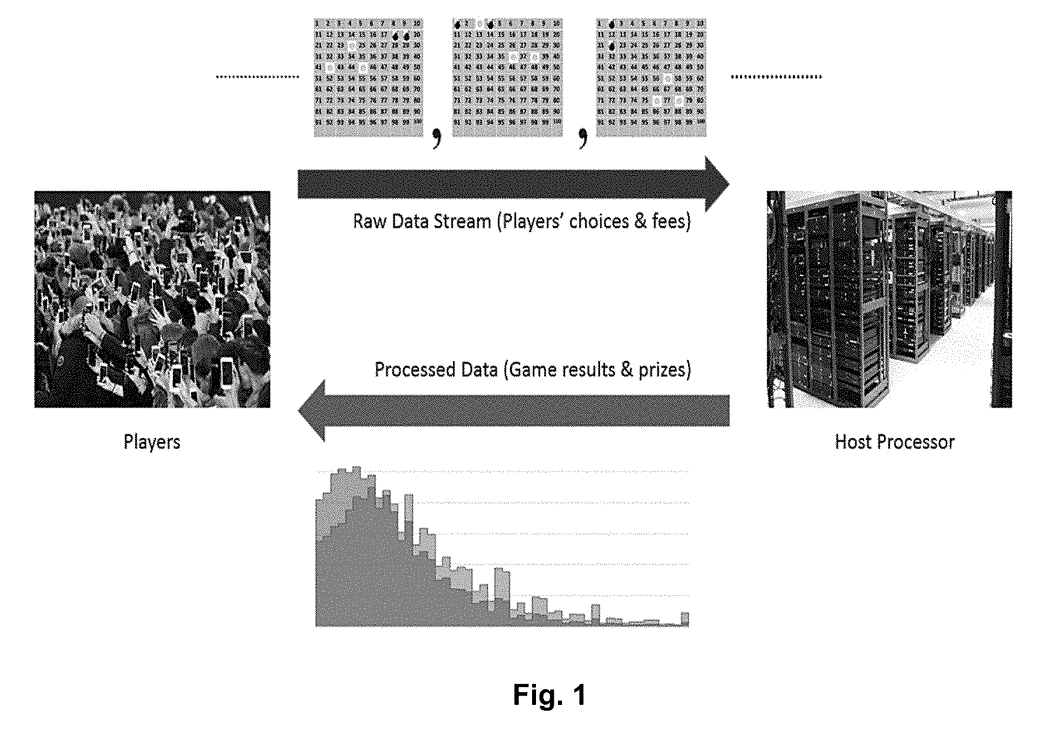

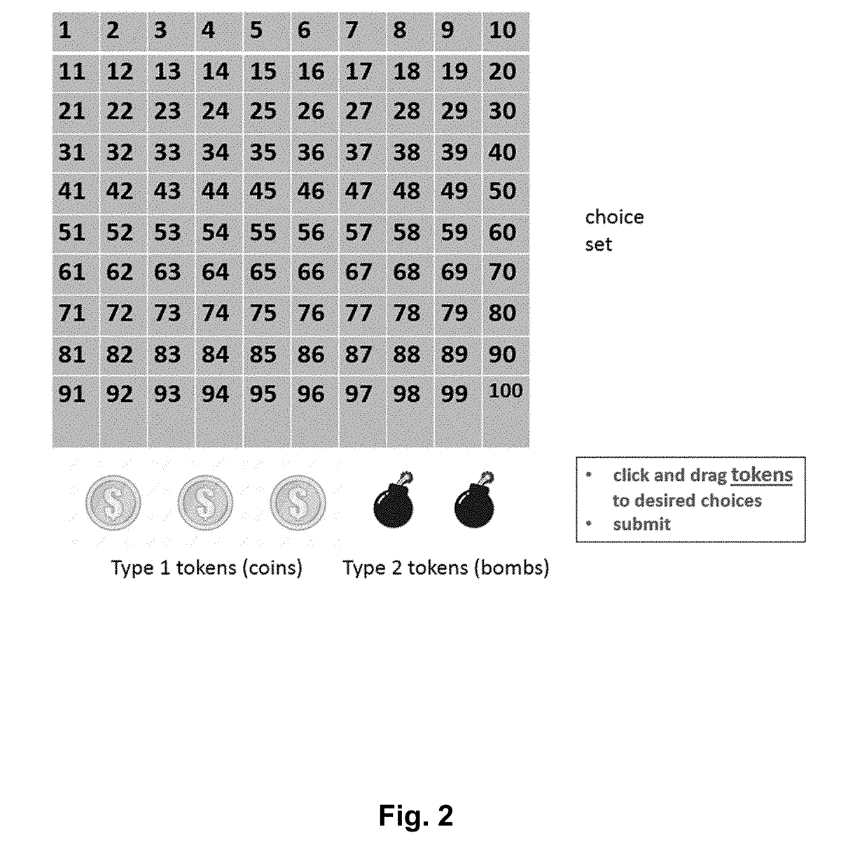

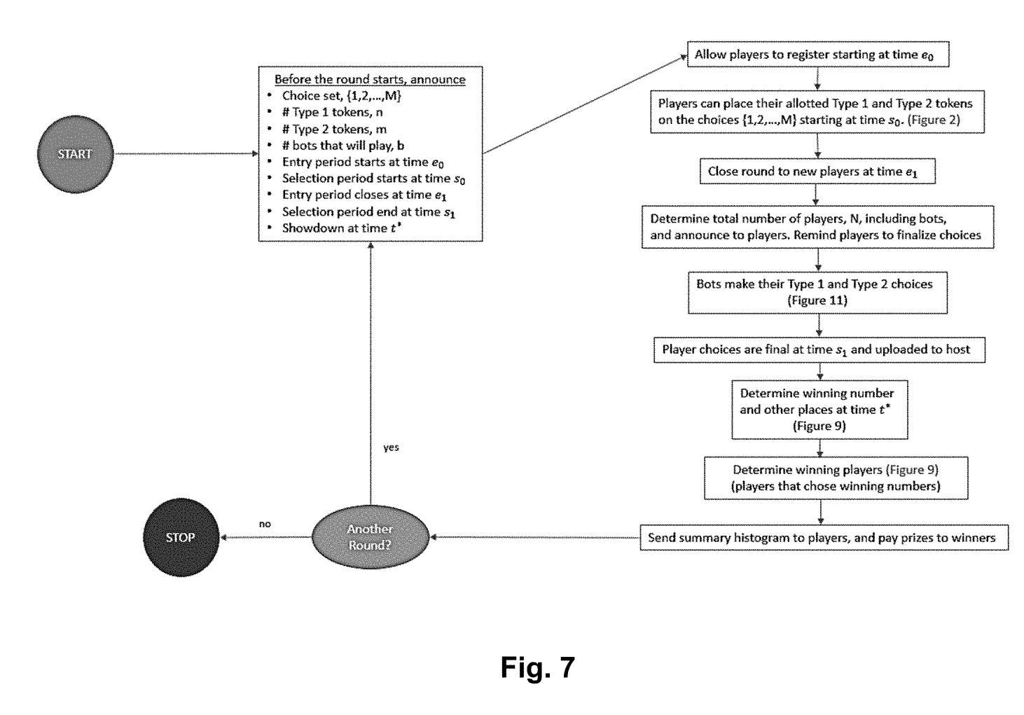

Preferably, the game of the present invention is provided to players using computers or other electronic devices like smart phones (their game interface devices) connected to a network, such as the internet. The game interface devices run a program or app specially designed for the game of the present invention. As shown in FIG. 1, a host processor is used to administer the game. A plurality of players therefore use game interface devices to connect to the host processor over the network. Players are able to pay entry fees and register for the round of the game during the entry period, and select where to place type 1 and type 2 tokens on the selection set during the selection period, using the interface devices. A screen shot of an embodiment of a game interface device for making type 1 and type 2 selections is illustrated in FIG. 2. The players' selections are communicated to, and confirmed by, the host processor at the end of the selection period, which then processes the data (FIG. 7). After processing the data the host processor sends summary histograms and personal results to each player, which are displayed on their game interface device.

The user interface devices can be any device able to connect to the host processor. For example, different players can make selections and pay fees using the same authorized kiosk at different times (similar to buying tickets for common lottery games at a convenience store), or players can log into the host processor using a personal computer or handheld electronic device (such as a smartphone). For personal computers or handheld devices, a specific application or website is needed to access the game. Allowing players to use computers or handheld devices encourages greater participation of the game, and also enables the game to be operated efficiently at small social setting such as at sports bars or restaurants.

In one typical embodiment of the game of the present invention, generally illustrated in FIG. 7, the host processor announces the rules of the upcoming round, such as what numbers or items can be selected, e.g., {1, 2, . . . , M} (the selection set), the number n of type 1 tokens each player is allowed to choose from the selection set, the number m of type 2 tokens each player is allowed to choose from the selection set, the number of bots that will play, b, the starting time of the entry period (when players can register for the round), the starting time of the selection period (when players can choose their numbers), the ending time of the entry period (no more players can register for that round), the ending time of the selection period (choices locked in), and the showdown time, when the winners are determined.

After the entry period ends the host processor preferably informs all the players of the total number of players in the round (human and bot) and the total number of type 1 and type 2 tokens that will be placed on the selection set by said players. The players can use that information to help them finalize their choices before the selection period ends.

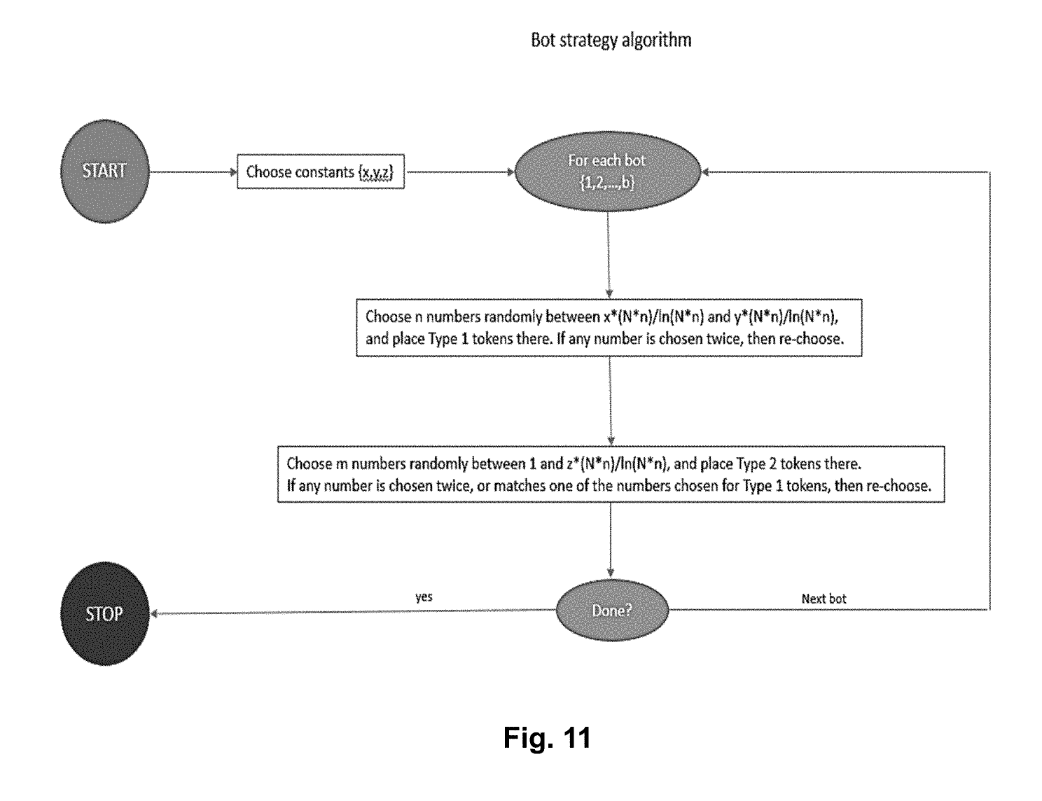

In one embodiment, the host processor determines what numbers the b bots will place their type 1 and type 2 tokens on after the entry period ends, according to a probability distribution (an embodiment is shown in FIG. 11). The type 1 tokens for each bot is placed on a number randomly from a probability distribution depending on N, n, m, and b ensuring that no number is chosen more than once. The type 2 tokens for each bot are placed on numbers randomly from another probability distribution depending on N, n, m, b, and the elements where the type 1 tokens were placed, ensuring that no type 2 tokens are placed where type 1 tokens are already placed. Optionally, the probability distribution for placing type 1 and type 2 tokens is based on the Nash equilibrium for the game of the present invention.

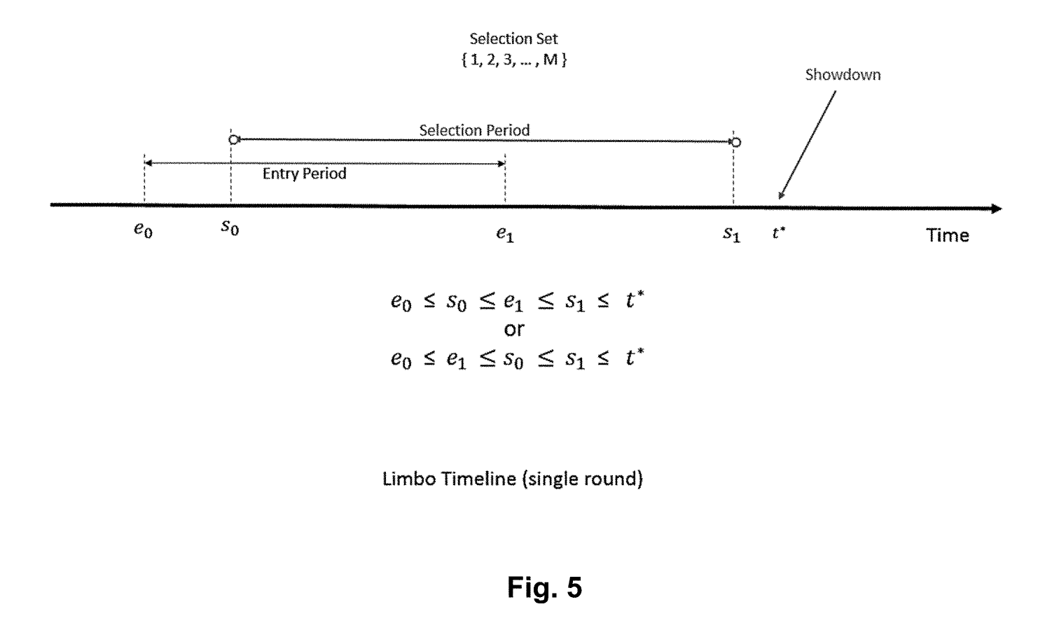

After the selection period ends, the game of the present invention enters the showdown phase where the host processor determines the winning numbers and players (possibly bots) and sends a summary of the round in histogram form (e.g., FIGS. 2 and 3) to all the players. Optionally, the histograms sent to the players are “personalized”, showing each player's choices color coded on the histogram, showing what place the player came in, and how much the player won. The timeline of a typical round of the game of the present invention is illustrated in FIG. 5.

Further non-limiting variations of the present invention are explained and described in the examples presented below.

### EXAMPLES

### Example 1—Minefield Limbo

In an embodiment of the lottery-like game described in U.S. Pat. No. 8,727,870 (Burton Simon), each of N players chooses a single number in the range {1, 2, . . . , M} When all the choices are in, the system determines the winner(s) by the following steps:

Determine kᵢ, i=1, 2, . . . , M, the number of players that chose i.

Determine k*, the minimum of {k₁, k₂, . . . , k_{M}}, excluding those that are 0.

Determine w, the smallest index such that k_{w}=k*. w is the winning number.

Determine the player(s) that chose w. These are the winning player(s).

It is a mathematical fact that if players do not communicate with each other and M is large enough compared to N, e.g., M>N/In(N), then k* will almost always be 1, i.e., there is a unique winner. There are four issues with the lottery-like game described in U.S. Pat. No. 8,727,870 that are addressed in the game of the present invention.

Firstly, the rules of the U.S. Pat. No. 8,727,870 game implicitly assume that players keep their choices secret from the other players, but there is often no way to enforce secrecy. If some players disregard this convention of secrecy then the nature of the game is subtly changed. For example, suppose M>N/In(N) so there will (almost certainly) be a unique winner. Now suppose a player (a “cheater”) announces over social media that he is going to choose item #1. Then the other players find themselves in an uncomfortable position. If they choose #1 then they know they will not win because the cheater already chose it. But if nobody “volunteers” to thwart the cheater, then the cheater will win. Of course, it is also possible the cheater is lying about his choosing item #1. This possibility makes the other players uncomfortable too. It would be preferable in a new game if cheating in this way could not benefit the cheater, and thereby players would not be tempted to cheat.

Secondly, the preferred embodiments of lottery-like game U.S. Pat. No. 8,727,870 are very simple since players choose a single number. It would be preferable in a new game if players choose multiple numbers and/or numbers with more than one purpose.

Thirdly, it would be advantageous to allow players the opportunity to play in rounds of the game where N (the number of players) is very large. But there may not always be large numbers of people available to play in every offered round. It would be preferable in a new game if the total number of players could be set at any level.

Fourthly, in the U.S. Pat. No. 8,727,870 game there is a winning number, and associated winning player(s), but there is no second place, third place, etc. It would be advantageous to have a method to assign placing besides first place.

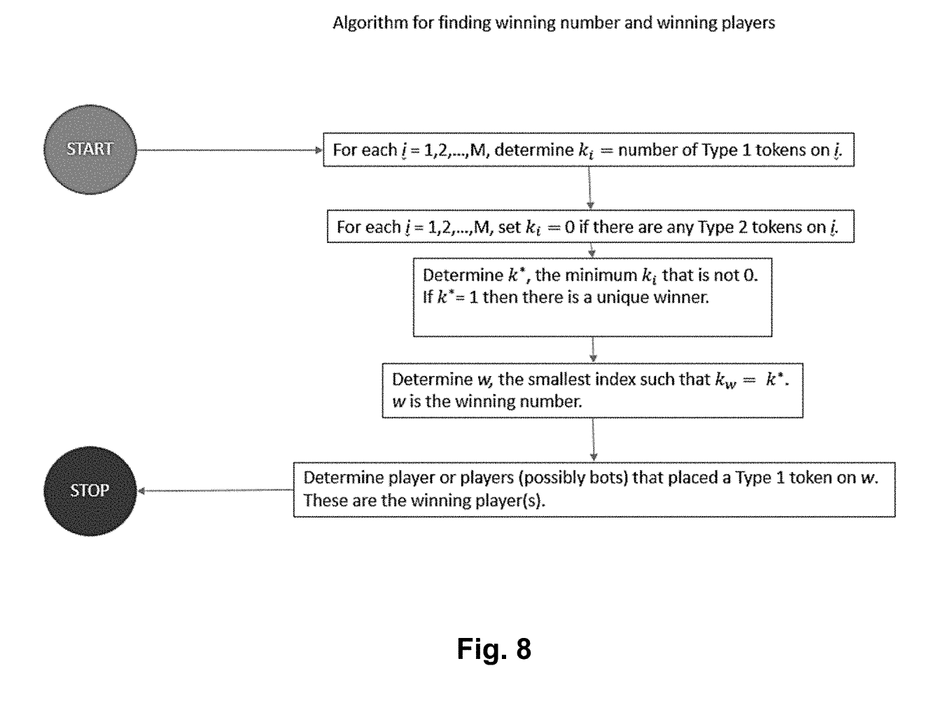

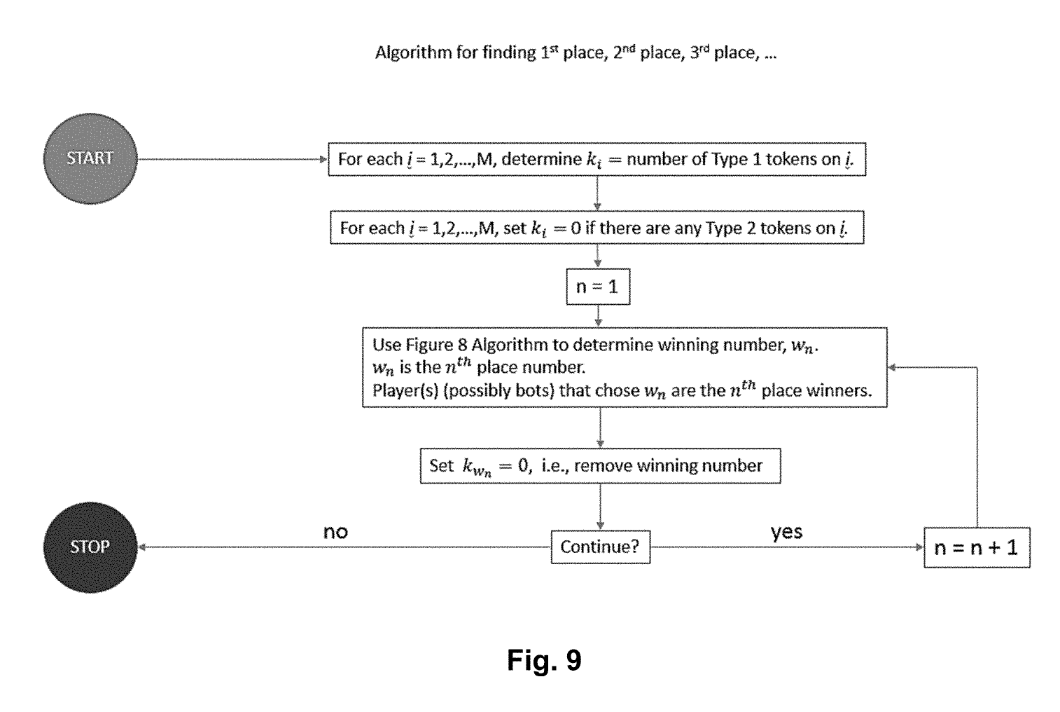

An embodiment of the game of the present invention, called Minefield Limbo, addresses all four issues described above. Minefield Limbo incorporates “bots”, which are virtual players, so (in principle) any number of players N is possible. In the game of the present invention there are two kinds of tokens, called type 1 tokens and type 2 tokens. Each player (including bots) gets n type 1 tokens (n≥1) and m type 2 tokens (m≥0), where n and m are set by the house. Each player places their n type 1 and m type 2 tokens on the M items in the selection set any way they want. When the players all make their choices the system determines the winner(s). The steps for determining the winner(s) in the game of the present invention are as follows: Remove all numbers from {1, 2, . . . , M} that have at least one type 2 token on them; and for or each of the remaining numbers, determine kᵢ, the number of players that chose i with a type 1 token; determine k*, the minimum of the kᵢ's, excluding those that are 0; determine w, the smallest item in the selection set such that k_{w}=k* (w is the winning number); determine the player(s) that chose w (these are the winning Player(s)) (FIG. 8); determine the placing of the non-winning numbers by sequentially removing the winning numbers and rerunning the winning number algorithm (FIG. 9.)

In the Minefield Limbo embodiment of the present invention, the type 2 tokens are called “bombs”. Any number with one or more bombs on it cannot be a winning number.

Minefield Limbo addresses and solves the problems identified above since if a player tries to “cheat” by announcing one or more of his choices, other players can place their type 2 tokens (bombs) on those choices without sacrificing their chances of winning (with their type 1 tokens). Cheating like this is obviously not a viable strategy in any embodiment of the game of the present invention. Additionally, since players place bombs, they must simultaneously decide where to put their own bombs, and how to avoid bombs placed by other players when they place their type 1 tokens. These strategic issues are multiplied in Minefield Limbo by increasing n and/or m. Furthermore, in every embodiment of the game of the present invention (including Minefield Limbo) the use of bots allows an unlimited number of players.

Thus, in addition to the selection of potential winning numbers (with type 1 tokens), this game allows each player to place a mine or bomb (with type 2 tokens) which prevents other players from winning with that designated number. If one player believes that another player may select (say) the number 13, placing a bomb on that number will prevent that number from being the winning number. If there is a bomb on some number, nobody can win with that choice.

A unique winning player in Minefield Limbo is therefore one that picks (with a type 1 token) the smallest bomb-free (type 2 token free) number that nobody else picks. There may not be a unique winning player in every game. If there is no unique winning player then the winning players are those that choose the winning number as defined above.

In Minefield Limbo there are second place and third place winners as well as (first place) winning players. One embodiment of an algorithm that assigns places to items in the choice set is illustrated in FIG. 9. The amounts that first place winners, second place winners, and other place winners are paid in prizes can be considered house rules.

Good strategies for Minefield Limbo are much more involved than strategies for the game described in U.S. Pat. No. 8,727,870. Placing bombs and avoiding bombs add additional variables successful players must take into consideration, and allotting multiple type 1 and type 2 tokens opens up a large variety of strategies concerning how the tokens should be spread out. A few simple strategies may be obvious: it is unwise to place a type 1 token on the same number twice, or to place a bomb where you have a type 1 token. Beyond that, each player must try to predict what numbers other players (and bots) are likely to select with their type 1 tokens and bombs.

In a further embodiment, there are multiple instances, s, of Minefield Limbo occurring simultaneously, i.e., with common entry period and selection periods, wherein players place their n type 1 tokens and m type 2 tokens on the selection sets for one or more of the s selection sets as they please. The players are constrained to a total of n type 1 tokens and m type 2 tokens, but otherwise they can distribute them among the s selections sets any way they want to. The winning number on each selection set is the smallest of the numbers with the least nonzero number of type 1 tokens that do not have any type 2 tokens on them, consistent with the usual rules of Minefield Limbo. Likewise, second place (and so on) are optionally determined for each selection set. Optionally, there are different prizes awarded to the winning players (players that chose the winning number, or placed) on each of the s Minefield Limbo games.

### Example 2—Top Limit Limbo

It is a mathematical fact that there is almost always a unique winner in games with a large number of players if the number of items in the selection set is sufficiently large. However, this is not true if players have to choose a number between 1 and M, where M is small enough so that every choice will (probably) be chosen by more than one player. For example, if M=100 and there are N=1000 players, each with n=5 type 1 tokens, then it would be expected that about (1000)(5)/100=50 type 1 tokens will be placed on each choice. As a result, there will probably be no unique winner. Of course there is always a unique winning number (unless every item in the selection set has a type 2 token on it) but the winning number almost always has multiple players that picked it when M is small. M in this scenario is called the Top Limit. The winning number in this embodiment would be the smallest of the least-popular-choices, consistent with the winning number for all embodiments of the present invention, i.e., the algorithm in FIG. 8. The winning players are those that chose the winning number. The rules for Top Limit Limbo are consistent with the rules described for Minefield Limbo.

If M (the Top Limit) is sufficiently large compared to N (the number of players), e.g., M>N/In(N), then there is probably a unique winner, so the probability an average player wins is about 1/N (the number of players). In a Top Limit Limbo game with a smaller M, the probability of winning is about 1/M. It is therefore much easier to win at Top Limit Limbo, but the individual prizes are smaller since the prize is shared by all the players that chose the winning number.

### Example 3—Jackpot Limbo

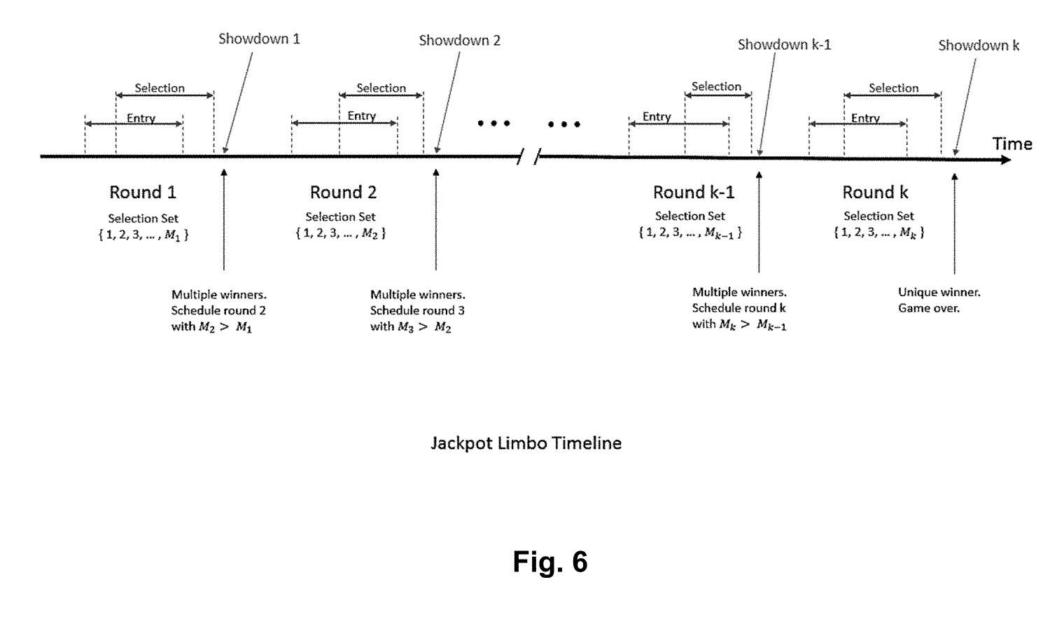

Top Limit Limbo can further be turned into a progressive jackpot game, as illustrated in FIG. 6. In Jackpot Limbo the contest starts with an initial jackpot, and the jackpot increases every round until somebody wins it. To win the jackpot in a given round, a player has to be the unique winner in that round.

To maximize the fun and suspense in Jackpot Limbo, the house sets the initial Top Limit small enough so that it is very unlikely there will be a unique winner, and increases Top Limit slowly in each subsequent round until finally there is a unique winner that wins the jackpot.

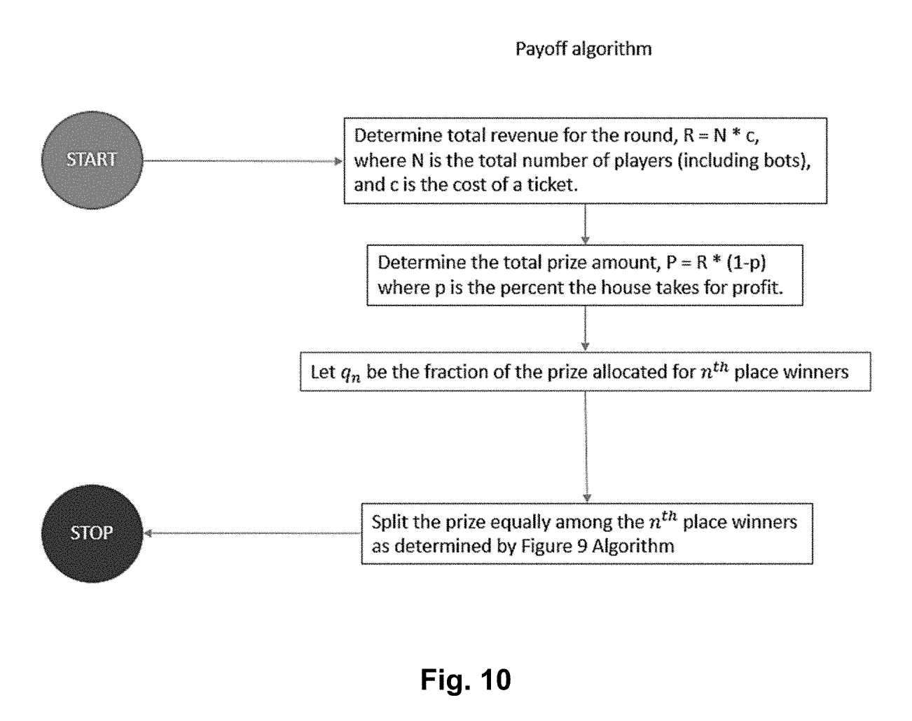

When there is no unique winner in a round of Jackpot Limbo, the round is like a normal round of Top Limit Limbo, i.e., the players that pick the winning number (the smallest least popular choice with no type 2 tokens on it) split the daily prize. The daily prize is some fraction of the ticket sales for the day (FIG. 10). Some of the remainder goes to increasing the jackpot for the next round.

Having now fully described the present invention in some detail by way of illustration and examples for purposes of clarity of understanding, it will be obvious to one of ordinary skill in the art that the same can be performed by modifying or changing the invention within a wide and equivalent range of conditions, elements and other parameters without affecting the scope of the invention or any specific embodiment thereof, and that such modifications or changes are intended to be encompassed within the scope of the appended claims.

When a group of materials, compositions or components is disclosed herein, it is understood that all individual members of those groups and all subgroups thereof are disclosed separately. When a Markush group or other grouping is used herein, all individual members of the group and all combinations and subcombinations possible of the group are intended to be individually included in the disclosure. Every combination of components described or exemplified herein can be used to practice the invention, unless otherwise stated. In the disclosure and the claims, “and/or” means additionally or alternatively. Moreover, any use of a term in the singular also encompasses plural forms.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein. All headings used herein are for convenience only.

1. A method of administering an interactive game between a host computer and a plurality of peripheral user interface devices comprising the steps:
a) transmitting from a host processor a discrete ordered selection set to the plurality of peripheral user interface devices, wherein the discrete ordered selection set comprises a plurality of selectable ranked items;
b) providing on each user interface device a number of electronic type 1 tokens and electronic type 2 tokens;
c) opening an entry period where players are able to join the game during the entry period through the user interface devices;
d) opening a selection period, wherein during the selection period the type 1 and type 2 tokens associated with each user interface device, independently from one another, are able to be linked with one or more of the selectable ranked items;
e) closing the entry period wherein after the entry period is closed, no further players are able to join the game;
f) closing the selection period wherein after the selection period is closed, no further type 1 and type 2 tokens are able to be linked to one or more of the selectable ranked items through the user interface devices, and wherein the closing of the selection period occurs after the closing of the entry period;
g) transmitting data from each user interface device to the host computer when the selection period is closed, wherein the transmitted data comprises which selectable ranked items are linked to the type 1 and type 2 tokens from each user interface device;
h) identifying via the host computer the smallest or lowest ranked item of the selectable ranked items having the least nonzero number of linked type 1 tokens from the transmitted data from the user interface devices and no linked type 2 tokens from the transmitted data from the user interface devices, and designating the identified smallest or lowest ranked item as the winning item;
i) determining via the host computer one or more winning players for the game, wherein the one or more winning players are players who linked a type 1 token to the winning item through the user interface devices; and
j) broadcasting results of the game to the plurality of peripheral user interface devices and displaying a summary of the results on the plurality of peripheral user interface devices.

2. The method of claim 1 further comprising:
the host computer providing one or more automated host players, wherein each automated host player randomly links a number of electronic type 1 and type 2 tokens with one or more of the selectable ranked items during the selection period according to a probability distribution; and
transmitting data to the host processor, wherein the transmitted data comprises which selectable ranked items are linked to the type 1 and type 2 tokens by the one or more automated host players.

3. The method of claim 2 wherein the probability distribution function is a Nash equilibrium strategy, or a probability distribution function that is approximately equal to the Nash equilibrium strategy.

4. The method of claim 1 wherein during the selection period, each linked type 1 and/or type 2 token on the user interface devices are able to be unlinked from the selectable ranked items and linked to a different item from the selectable ranked items, and wherein data comprising the selectable ranked items linked to the type 1 and type 2 tokens when the selection period is closed is transmitted to the host computer.

5. The method of claim 1 comprising administering a plurality of simultaneous subgames having common entry periods and selection periods and having separate sets of selectable ranked items,
wherein the type 1 and type 2 tokens associated with each user interface device are able to be linked to one or more of the selectable ranked items in any of the sets of selectable ranked items associated with said subgames,
wherein the number of type 1 and type 2 tokens able to be collectively linked to the sets of selectable ranked items is finite, and when the common selection periods close, a winning item is determined for each subgame, and the winning players are players who linked type 1 tokens on the winning items in one or more of the subgames.

6. The method of claim 1 further comprising displaying on the user interface devices, time remaining before the entry period, selection period, or both, are closed.

7. The method of claim 1 further comprising displaying on the user interface devices, the current total number of players that have joined the game during the entry period, and the final player count after the entry period ends.

8. The method of claim 2 further comprising displaying on the user interface devices, the number of automated host players participating in the game.

9. The method of claim 1 further comprising collecting a bet or a fee from each player when the player joins the game.

10. The method of claim 9 further comprising paying each of the one or more winning players a percentage of the collected bets or fees.

11. The method of claim 1 wherein the selection set is a set of whole numbers, or a set of alphabetical symbols in alphabetical order, or a set of Roman numerals, or a set of whole numbers using the reverse ordering (largest to smallest).

12. The method of claim 1 further comprising constructing a histogram on the host computer from the transmitted data from the user interface devices and electrically communicating the histogram to the user interface devices.

13. The method of claim 12 where the step of constructing the histogram comprises the steps of:
a) determining the number of players that linked a type 1 token on each item in the selection set, and the number of players that linked a type 2 token on each item in the selection set, thereby generating a result set;
b) displaying the result set as a histogram where a color-coded bar above each item in the selection set shows the number of type 1 and type 2 tokens linked to that item;
c) electrically communicating the histogram to the user interface devices along with a summary of winning items and prizes.

14. The method of claim 1 further comprising determining a second place item, wherein said second place item is determined by an algorithm after the winning item is identified, and determining an n-th place item, wherein said n-th place item is determined by the same algorithm after the (n−1)-st place item is found.

15. A method of administering an interactive game comprising of one or more rounds between a host computer and a plurality of peripheral user interface devices, wherein each round comprising the steps of:
a) transmitting from a host processor a discrete ordered selection set to the plurality of peripheral user interface devices, wherein the discrete ordered selection set comprises a plurality of selectable ranked items;
b) providing on each user interface device a number of electronic type 1 tokens and electronic type 2 tokens;
c) opening an entry period where players are able to join the game during the entry period through the user interface devices;
d) opening a selection period, wherein during the selection period the type 1 and type 2 tokens associated with each user interface device, independently from one another, are able to be linked with one or more of the selectable ranked items;
e) closing the entry period wherein after the entry period is closed, no further players are able to join the game;
f) closing the selection period wherein after the selection period is closed, no further type 1 and type 2 tokens are able to be linked to one or more of the selectable ranked items through the user interface devices, and wherein the closing of the selection period occurs after the closing of the entry period;
g) transmitting data from each user interface device to the host computer when the selection period is closed, wherein the transmitted data comprises which selectable ranked items are linked to the type 1 and type 2 tokens from each user interface device;
h) identifying via the host computer the smallest or lowest ranked item of the selectable ranked items having the least nonzero number of linked type 1 tokens from the transmitted data from the user interface devices and no linked type 2 tokens from the transmitted data from the user interface devices, and designating the identified smallest or lowest ranked item the winning item;
i) determining via the host computer one or more winning players for the round, wherein the one or more winning players are players who linked a type 1 token to the winning item through the user interface devices; and
j) determining if there is a single unique winning player in the round, in which case said unique winner is awarded a prize; wherein if there is no single unique winner in the round, the prize is not awarded, and another round is scheduled.

16. The method of claim 15 wherein the provided selection set is larger in successive rounds.

17. The method of claim 15 wherein the prize for a round is increased by a fraction of fees collected in a previous round.

18. The method of claim 15 wherein a consolation prize is awarded to multiple winning players in rounds when there is no single unique winning player.

19. An apparatus for providing an interactive game between a plurality of players, where said system comprises:
a) a host processor programmed for collecting and processing input data, and outputting data and information relevant to the game; and
b) one or more user interface stations connected to said host processor, said one or more user interface stations able to send player selection input to said host processor, and said host processor able to send data and information to the user interface stations;
wherein said host processor is programmed to:
i) transmit to each user interface station a discrete ordered selection set, wherein the selection set comprises a plurality of selectable ranked items, and also provide to each user interface station a number of electronic type 1 and electronic type 2 tokens;
ii) open an entry period where the players are able to join the game during the entry period through the user interface stations;
iii) open a selection period, wherein during the selection period the type 1 and type 2 tokens associated with each user interface station, independently from one another, are able to be linked with one or more of the selectable ranked items;
iv) close the entry period wherein after the entry period is closed, no further players may join the game;
v) close the selection period, wherein after the selection period is closed, no further type 1 and type 2 tokens are able to be linked to one or more of the selectable ranked items through the user interface stations, and wherein the closing of the selection period occurs after the closing of the entry period;
vi) transmit data from each user interface station to the host computer when the selection period is closed, wherein the transmitted data comprises which selectable ranked items are linked to the type 1 and type 2 tokens from each user interface station;
vii) identify which selectable ranked items in the selection set, among those that did not contain type 2 tokens, contained the least number of type 1 tokens with at least r type 1 tokens, where r>0;
viii) identify the smallest or lowest ranked item of the selectable ranked items that have at least r type 1 tokens and no type 2 tokens, and designate the identified smallest or lowest ranked item as the winning item; and
ix) determine the one or more winning players for the game, wherein the one or more winning players are the players who linked a type 1 token to the winning item.

20. The system of claim 19 wherein each of the one or more user interface stations comprise one or more computer processors connected to a network able to transmit data to the host processor.
